(19) United States
(12) Patent Application Publication
(10) Pub. No.: US 2016/0057946 A1
(43) Pub. Date: Mar. 3, 2016

(54) TIMBER-WORKING DEVICE AND METHOD OF OPERATION

(71) Applicants: Brett James Kaye, Tauranga (NZ); Justyn Peter Smythe, Cambridge (NZ)

(72) Inventors: Brett James Kaye, Tauranga (NZ); Justyn Peter Smythe, Cambridge (NZ)

(21) Appl. No.: 14/837,578

(22) Filed: Aug. 27, 2015

(30) Foreign Application Priority Data
Aug. 29, 2014 (NZ) 629666

(51) Int. Cl. A01G 23/099; G01D 5/26

(52) U.S. Cl. CPC A01G 23/099; G01D 5/26

(57) ABSTRACT

A timber-working device has a frame, including a feed axis having first and second sides. A drive system independently feeds stems along the feed axis, and has a first rotary drive having a first wheel acting against a first stem on the first side, and a second rotary drive having a second wheel acting against a second stem on the second side. The device has at least two distance measurement devices, each side of the feed axis having an associated distance measurement device. Each generates measurement signals indicative of the length of stems fed along the feed axis, at least one of them indicative of rotation of one of the rotary drives. A processor receives the respective measurement signals, and for each of the first and second stems, determines the length of at least a portion of the stem fed by the drive system based at least in part on the respective measurement signals.

### CROSS-REFERENCE TO RELATED APPLICATIONS

This application claims priority under 35 U.S.C. §119 to New Zealand Application No. 629666, filed Aug. 29, 2014, and entire contents of which are incorporated herein by reference.

### STATEMENT OF FEDERALLY SPONSORED RESEARCH AND DEVELOPMENT

Note applicable.

### FIELD OF THE DISCLOSURE

The present disclosure relates to a timber-working device and method of operation.

### BACKGROUND OF THE DISCLOSURE

It is well-known to mount timber-working devices, often referred to as forestry or harvester heads, to a carrier vehicle in order to perform a number of operations in connection with timber processing. These operations may include one, or a combination of, grappling and felling a standing tree, delimbing a felled stem, debarking the stem, and cutting the stem into logs (known as bucking)—commonly using at least one chainsaw.

Many such harvester heads have the ability to measure the length of the stem, for example using a frame mounted measuring wheel, the rotation of which as a stem passes is measured using an encoder to infer length. This data may be used to determine the optimal position of saw cuts in order to maximise the value of logs obtained from that stem, and the pile the logs should be sorted into for further processing.

More recently, some forestry heads have been configured for processing multiple stems at a time, in which stems may be fed through the head independently from each other. However, such heads do not measure the lengths of these stems independently. This can require the operator to make decisions with less than optimal information, impacting on productivity and log quality.

Alternatively, operators may be particularly selective of stems they pick up simultaneously for processing—in particular selecting stems of a similar length and diameter—to reduce the decision making required during processing in the knowledge that the stems may be treated effectively the same. However, this sorting and picking process adds time and therefore cuts into productivity.

It is an object of the present disclosure to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

Throughout this specification, the word “comprise” or “include”, or variations thereof such as “comprises”, “includes”, “comprising” or “including” will be understood to imply the inclusion of a stated element, integer or step, or group of elements integers or steps, but not the exclusion of any other element, integer or step, or group of elements, integers or steps.

Further aspects and advantages of the present disclosure will become apparent from the ensuing description which is given by way of example only.

### SUMMARY OF THE DISCLOSURE

According to an example embodiment of the present disclosure there is provided a timber-working device, comprising a frame. The frame comprises a feed axis having first and second sides relative to the frame. The timber-working device comprises a drive system configured to independently feed stems along the feed axis. The drive system comprises a first rotary drive having a first wheel configured to act against a first stem on the first side of the feed axis, and a second rotary drive having a second wheel configured to act against a second stem on the second side of the feed axis. The timber-working device comprises at least two distance measurement devices. Each side of the feed axis has an associated distance measurement device, each configured to generate measurement signals indicative of the length of stems fed along the feed axis. At least one of the distance measurement devices is associated with one of the rotary drives and its measurement signal is indicative of rotation of the drive. The timber-working device comprises at least one processor configured to receive the respective measurement signals, and for each of the first and second stems, determine the length of at least a portion of the stem fed by the drive system based at least in part on the respective measurement signals.

According to an example embodiment of the present disclosure there is provided a method for determining the respective lengths of at least portions of a first stem and a second stem independently fed along a feed axis of a timber-working device by a first rotary drive and a second rotary drive respectively. The method comprises the step of receiving measurement signals from distance measurement devices indicative of the length of stems fed along the feed axis, wherein at least one of the measurement signals is indicative of rotation of one of the rotary drives. The method further comprises the step of: for each of the first and second stems, determining the length of at least a portion of the stem fed by the drive system based at least in part on the respective measurement signals.

According to an example embodiment of the present disclosure there is provided an article of manufacture having computer storage medium storing computer readable program code executable by a computer to implement a method for determining the respective lengths of at least portions of a first stem and a second stem independently fed along a feed axis of a timber-working device by a first rotary drive and a second rotary drive respectively. The code comprises computer readable program code receiving measurement signals from distance measurement devices indicative of the length of stems fed along the feed axis, wherein at least one of the measurement signals is indicative of rotation of one of the rotary drives. The code further comprises computer readable program code determining, for each of the first and second stems, the length of at least a portion of the stem fed by the drive system based at least in part on the respective measurement signals.

The timber-working device may be a forestry or harvester head, and may be referred to as such throughout the specification. Forestry heads typically have the capacity to grapple and fell a standing tree, delimb and/or debark a felled stem, and cut the stem into logs. However, a person skilled in the art should appreciate that the present disclosure may be used with other timber-working devices, and that reference to the timber-working device being a forestry head is not intended to be limiting.

The rotary drive may be any suitable actuator for producing rotary motion as known to a person skilled in the art. For example, the rotary drives may be fluid driven—such as hydraulic motors. However, it should be appreciated that this is not intended to be limiting.

A distance measuring device may be any suitable means known to those skilled in the art for measuring the length of at least a portion of a stem passing a point on the frame as it is fed along the feed axis by the drive system.

The distance measuring device for determination of rotation of a rotary drive may be any suitable means known to a person skilled in the art. For example, in an example embodiment the distance measuring device may be a rotary encoder. The encoder may operate, for example, using mechanical, optical, magnetic, or capacitive principles to determine rotation of the portion of the drive to which the wheel is mounted. It should be appreciated that reference to rotation of the rotary drive may comprise partial rotation of the wheel, and/or number of complete revolutions.

Given known geometry of components of the device—particularly the diameter of the wheels engaging the stems—the length of the stem being fed by the wheels may then be determined. For example, length of at least a portion of a stem which has been fed by a rotary drive may be determined as follows: Length=Wheel Circumference×Revolutions.

In example embodiments determination of length may be based, at least in part, on the species of the first and/or second stem. The wheels of rotary drives commonly have a gripping surface comprising projections (whether teeth or blades) which penetrate the surface of stems being held and fed by the drive system. The species of the tree being processed with influence, among other things, the depth to which the gripping surface penetrates. This depth of penetration alters the effective diameter of the wheel and therefore circumference. As such, it is envisaged that accuracy of length determination based on rotation of the rotary drive may be assisted by accounting for species.

In example embodiments, an indication of the species of the stem may be input to the processor by an operator of the timber-working device, as known in the art. The selection may be persistent—i.e. determination of stem length may be based on a previously selected species until an indication of a different species is received. It should be appreciated that in example embodiments, automated determination of species may be performed and used in determination of stem length.

According to an example embodiment of the present disclosure there is provided a method for determining the length of at least portions of a stem fed along a feed axis of a timber-working device by a first rotary drive and a second rotary drive. The method comprises the step of receiving a measurement signal from a distance measurement device indicative of the length of the stem fed along the feed axis, wherein the measurement signal is indicative of rotation of one of the rotary drives. The method further comprises the steps of determining the species of the stem, and determining the length of at least a portion of the stem fed by the drive system based at least in part on the measurement signal, and the species of the stem.

In an example embodiment, one of the distance measuring devices may be a measuring wheel, as known in the art. Such a measuring wheel may be brought into contact with a stem, and an encoder used to generate a signal indicative of the wheel's revolutions which may be used to determine the length of stem driven relative to the measuring wheel.

It is envisaged that the measuring wheel may be laterally offset from feed axis, such that the measuring wheel may be used to measure the length of one stem when two stems are being processed by the timber-working device simultaneously, as well as during single stem processing.

In an example embodiment, the measurement signal of the measuring wheel may be given preference over the measurement signal of a distance measurement devices associated with one of the rotary drives. For example, where two stems are to be driven simultaneously, the measurement signal of the measuring wheel may be used to infer length measurement of the stem with which the measuring wheel is not in contact. Inaccuracy in length determination based on rotation of a rotary drive may be introduced in cases where the wheels of the drive mechanism slip. As the measuring wheel is not driven, it is not as susceptible to false readings in this regard.

The measurement signal from the measuring wheel may be used in comparison with that of the rotary drives to assess accuracy of the length determination performed using the signals from the rotary drives. In example embodiments, the measurement signal from the distance measurement device associated with a rotary drive may be compared with that from the measuring wheel to identify loss of traction by the wheel of the rotary drive, Where the rotary drive is identifying as travelling further than the measuring wheel, this is indicative that the rotary drive's wheel is slipping. Control of the rotary drive may be adjusted accordingly.

In addition to determining the overall length of the stems, the drive system may be controlled to independently feed the respective stems to target lengths. The timber-working device may comprise a cutting device—for example at least one saw. It is known for forestry heads to comprise a main chainsaw which is primarily used for the felling and cross cutting of stems. Further, some forestry heads may comprise a secondary or topping chainsaw. The topping saw is typically of a lower specification than the main saw, and used primarily during processing once a tree is felled. Reference to the cutting device being a chainsaw is not intended to be limiting, as the saw may take other forms—for example a disc saw. Further, the cutting device may take other forms known in the art, for example a shear.

In an example embodiment, the length measurement of the respective stems may be used to drive the stems to predetermined points along the feed axis. The predetermined points along the feed axis may be one or more cutting positions at which one or both of the stems are to be severed by the cutting device. The act of feeding a stem to a target length and severing it with a cutting device may herein be referred to as processing the stem.

Such cutting positions may be determined on the basis of target lengths of logs to be produced from the stem. Such target lengths may be designated by the operator, or as part of an automated value optimisation determination, as known in the art in relation to single stem processing.

The respective diameters of the stems may be determined using any suitable means known in the art. For example, in a configuration well known in the art the rotary drives may be mounted to drive arms pivotally attached to the frame. The drive arms may be driven, for example using hydraulic cylinders, between open and closed positions to grapple and release stems using the feed wheels.

Angular deflection of the drive arms may be used in conjunction with known geometries of the timber-working device to infer the diameter(s) of the stems held by the arms. Similarly, the timber-working device may comprise delimb arms configured to be closed about the stems, having sharpened edges to cut limbs from the stems as they are fed by the drive system. As with the drive arms, angular position of the delimb arms may be used to determine stem diameter.

The determined diameters of the stems may influence processing of the individual stems. In an example embodiment, a target length for a cutting position of a stem may be adjusted on the basis of the determined diameter for that stem.

For example, the timber-working device may determine that one of the stems has reached a minimum diameter, and adjust the target length to one which may be achieved before the minimum diameter occurs. It should be appreciated that this may comprise proposing the adjusted target length to the operator for approval prior to actioning the adjustment. Where the minimum diameter has been reached for one stem, the other stem may be independently fed to achieve its previously determined target length before the stems are severed using the cutting device.

In an example embodiment, where the measuring wheel is in contact with the stem with the comparatively shorter target length as the result of diameter limiting (for example the first stem), both stems may be driven simultaneously to the target length of the first stem using the measurement signal from the measuring wheel. The second stem may then be driven to its comparatively longer target length using the measurement signal from the distance measuring device associated with the rotary drive used to feed the second stem. In doing so, the accuracy of the measuring wheel may be utilised for both stems. Further, by not feeding the first stem to the second stem's target length and subsequently reversing the first stem, the risk of the first stem breaking due to the weight on the undersized diameter held by the head may be reduced.

In another embodiment, a comparison of the respective diameters may be performed. Where the difference in diameter of the two stems is greater than a predetermined threshold, the stem having the greater diameter may be processed until it is determined that the differential is below the threshold. The stems may then be processed simultaneously—enabling grouping of the resulting logs to reduce labour associated with subsequently sorting the pile. In example embodiments, the drive system may comprise a frame mounted rotary drive on either side of the feed axis, which may be controlled independently to each other. Where two stems are grasped by drive arms, these frame mounted wheels may be controlled together with those of the respective drive arms to independently control the relative positions of the two stems along the feed axis.

In an embodiment, the rotary drives of the drive arms comprise the distance measurement devices. The wheels of the drive arms may be where slipping predominantly occurs due to pressure exerted by the arms, and the signals generated by the distance measurement devices may be used to detect such loss of traction. However, it should be appreciated that this is not intended to be limiting; where a frame mounted drive and arm mounted drive are used in conjunction to feed a stem, either or both of the drives may be configured to output a signal indicative of rotation of the respective drives.

Where rotation of both frame and arm mounted drives is measured, it is envisaged that these may be compared to determine loss of traction or slipping of one or more of the wheels. For example, where the signal from the arm mounted drive indicates that the rate of rotation of the drive has accelerated, while rotation of the frame mounted drive does not increase proportionally, this may indicate that the arm mounted wheel has lost traction. This comparison may be used to select a preferred length measurement—in the example above the length measurement obtained from the frame mounted drive may be preferred until the arm mounted wheel has regained traction.

The various illustrative logical blocks, modules, circuits, and algorithm steps described in connection with the embodiments disclosed herein may be implemented as electronic hardware, computer software, or combinations of both. In particular, they may be implemented or performed with a general purpose processor such as a microprocessor, or any other suitable means known in the art designed to perform the functions described.

The steps of a method or algorithm and functions described in connection with the embodiments disclosed herein may be embodied directly in hardware, in a software module executed by a processor, or in a combination of the two. If implemented in software, the functions may be stored as processor readable instructions or code on a tangible, non-transitory processor-readable medium—for example Random Access Memory (RAM), flash memory, Read Only Memory (ROM), hard disks, a removable disk such as a CD ROM, or any other suitable storage medium known to a person skilled in the art. A storage medium may be connected to the processor such that the processor can read information from, and write information to, the storage medium.

The details of one or more embodiments are set forth in the accompanying drawings and the description below. Other features and advantages will become apparent from the description, the drawings, and the claims.

### BRIEF DESCRIPTION OF DRAWINGS

Further aspects of the present disclosure will become apparent from the following description which is given by way of example only and with reference to the accompanying drawings in which:

FIG. 1 is a side view of an example timber-working system having an example forestry head;

FIG. 2 is an elevated view of the exemplary forestry head;

FIG. 3 is a diagrammatic view of an example control system for the timber-working system;

FIG. 4 is a flowchart illustrating an example method for operating the forestry head;

FIG. 5A-C are elevated views of the forestry head in operation according to the method of FIG. 4;

FIG. 6 is a flowchart illustrating another example method for operating the forestry head;

FIG. 7A-C are elevated views of the forestry head in operation according to the method of FIG. 6;

FIG. 8 is a sectional view of an example feed wheel for use with an example forestry head, and

FIG. 9 is a flowchart illustrating an example method of determining the length of stems processed using an example forestry head;

### DETAILED DESCRIPTION

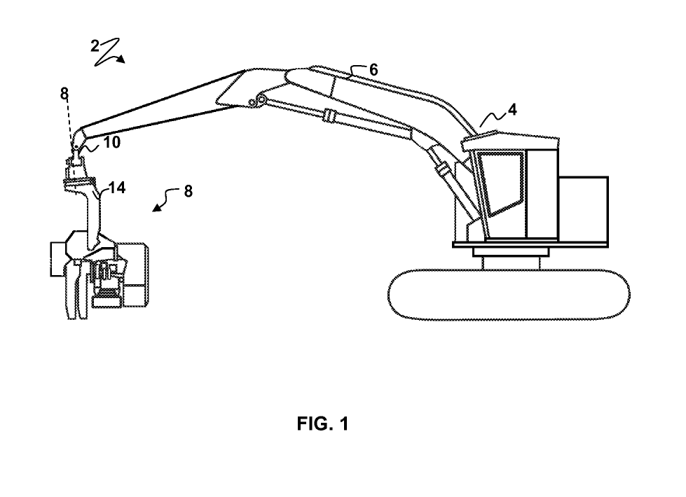

FIG. 1 illustrates a timber-working system comprising a carrier 2 for use in forest harvesting. The carrier 2 comprises an operator cab 4 from which an operator (not shown) controls the carrier 2. The carrier 2 further comprises a boom assembly 6, to which a timber-working device in the form of a forestry head 8 is connected. Connection of the head 8 to the arm 6 comprises a rotator 10, configured to rotate the head 8 about the generally vertical axis of rotation marked by dashed line 12. A tilt bracket 14 further allows rotation of the head 4 between a prone position (as illustrated) and a standing position.

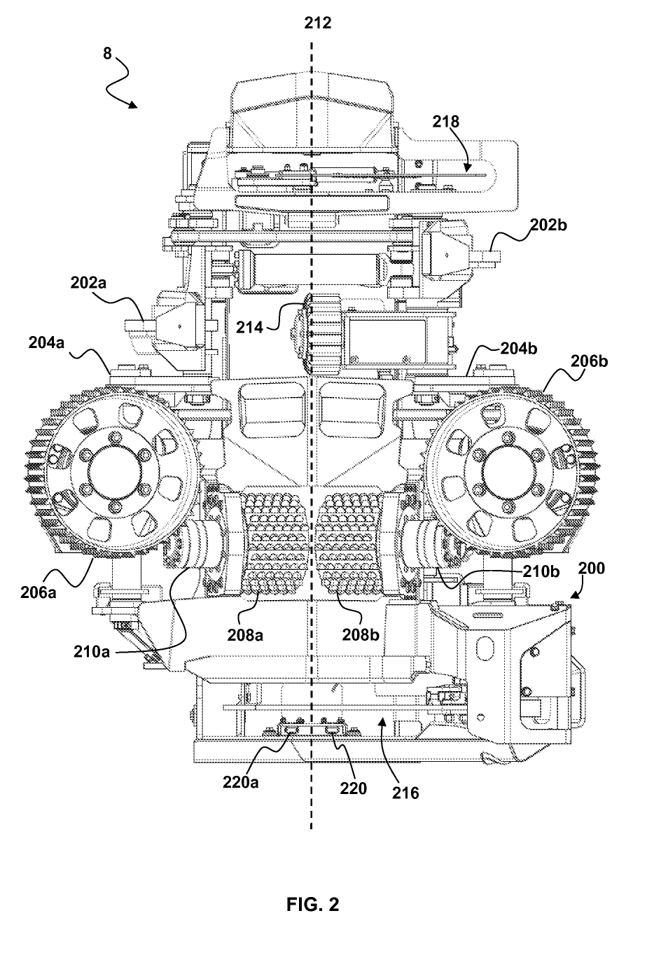

Referring to FIG. 2, the head 8 comprises a frame 200 to which the tilt bracket 14 of FIG. 1 is pivotally attached. Right hand (RH) and left hand (LH) delimb arms 202a and 202b are pivotally attached to the frame 200, as are opposing RH and LH feed arms 204a and 204b. RH and LH feed wheels 206a and 206b are attached to RH and LH feed arms 204a and 204b respectively via associated rotary drives (not illustrated in FIG. 2). RH and LH frame-mounted feed wheels 208a and 208b are driven by RH and LH frame mounted drives 210a and 210b, and together with feed wheels 206a and 206b may be controlled to feed one or more stems (not illustrated) along feed axis 212 of the head 8. Feed wheels 206a, 206b, 208a and 208b and their associated rotary drives may collectively be referred to as the ‘feed system.’

A measuring wheel 214 may be lowered to come in contact with a passing stem in order to measure length. The measuring wheel 214 is offset laterally from the feed axis 212, such that it only contacts a stem held on the LH side of the feed axis when two stems are held by the head 8, but while single stemming—i.e. only a single stem held by feed arms 204a and 204b—the measuring wheel 214 can still contact that single stem.

A main chainsaw 216, and a topping chainsaw 218, are attached to the frame 200. The main saw 216 is typically used to fell a tree when the head 8 is in a harvesting position, and to buck stems into logs in the processing position of the head 8 (as seen in FIG. 1). The topping saw 218 may be used to cut off a small-diameter top portion of the stem(s) to maximize the value recovery of the trees.

RH and LH optical sensors 220a and 220b are attached to the frame 200 on either side of the feed axis 212. These sensors 220a and 220b may be used to detect the respective ends of stems held by the head 8.

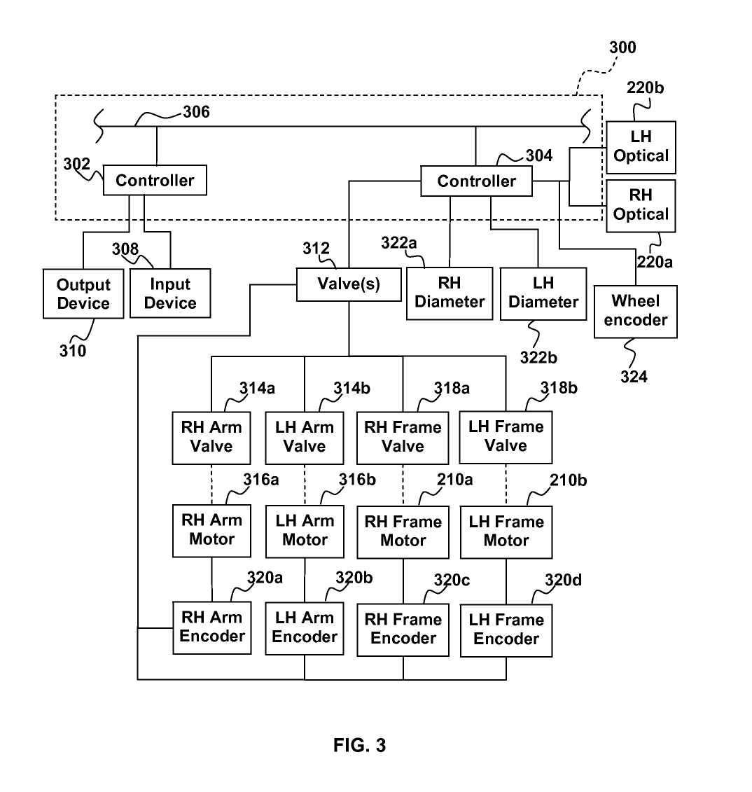

The various operations of the head 8 may be controlled by the operator using hand and foot controls as known in the art. Further, certain automated functions of the harvester head 4 may be controlled by an electronic control system 300 as shown by FIG. 3. Description of the electronic control system 300 may comprise reference to features of FIG. 1 and/or FIG. 2.

The control system 300 comprises one or more electronic controllers, each controller comprising a processor and memory having stored therein instructions which, when executed by the processor, causes the processor to perform the various operations of the controller.

For example, the control system 300 comprises a first controller 302 on board the carrier 2 and a second controller 304 on board the head 8. The controllers 302, 304 are connected to one another via a communications bus 306 (e.g., a CAN bus).

A human operator operates an operator input device 308, for example hand and foot controls, located at the operator's cab 4 of the carrier 2 to control the head 8. Details of operation are output to an output device 310—for example a monitor. Certain automated functions may be controlled by first controller 302 and/or second controller 304.

The RH and LH optical sensors 220a and 220b are electronically coupled to the second controller 304, and configured to output respective signals indicative of the end of a stem being present within the respective sensing regions associated with the sensors 220a and 220b.

The head 8 has a number of valves 312 arranged, for example, in a valve block and coupled electrically to the second controller 304 so as to be under its control. The valves 312 comprise, for example, drive valves 314a and 314b configured to control operation of the hydraulic motors 316a and 316b associated with the RH and LH feed wheels 206a and 206b, and drive valves 318a and 318b and configured to control operation of the RH and LH frame mounted drives 210a and 210b associated with RH and LH frame-mounted feed wheels 208a and 208b.

The valves 312 further comprise drive valves for controlling operation of the saws 216 and 218.

Rotary encoders 320a, 320b, 320c and 320d may be associated with rotary drives 316a, 316b, 210a, and 210b respectively, and electronically coupled to the second controller 304. It should be appreciated that, in embodiments, encoders may not be provided for each rotary drive—i.e. only one drive on each side may be provided with an encoder.

Each rotary encoder 320a, 320b, 320c and 320d is configured to output a signal indicative of rotation of the drives 316a, 316b, 210a, and 210b and thus feed wheels 206a, 206b, 208a and 208b. For known wheel diameters, the length of a stem driven by the wheels may be determined by multiplying the rotation value by the wheel circumference. It should be appreciated that the value of the rotations in a reverse direction may be subtracted from rotations in a forward direction to determine the length ultimately traversed.

Angular position sensors—for example RH rotation sensor 322a mounted to delimb arm 202a and/or feed arm 204a, and LH rotation sensor 322b mounted to delimb arm 202b and/or feed arm 204b—are electronically coupled to the second controller 304. Each is configured to output a signal indicative of the angular position of the associated arm. As an example, the rotation sensors 322a and 322b are rotary encoders.

A measuring wheel encoder 324 is electrically coupled to the second controller 304, and configured to output a measuring signal indicating the length of the stem(s) that has passed the measuring wheel 214 when lowered. When processing a single stem, the output of the rotary encoders 320a, 320b, 320c and 320d is compared with the measurement performed by encoder 324 in order to identify deviation which may require re-calibration to improve accuracy.

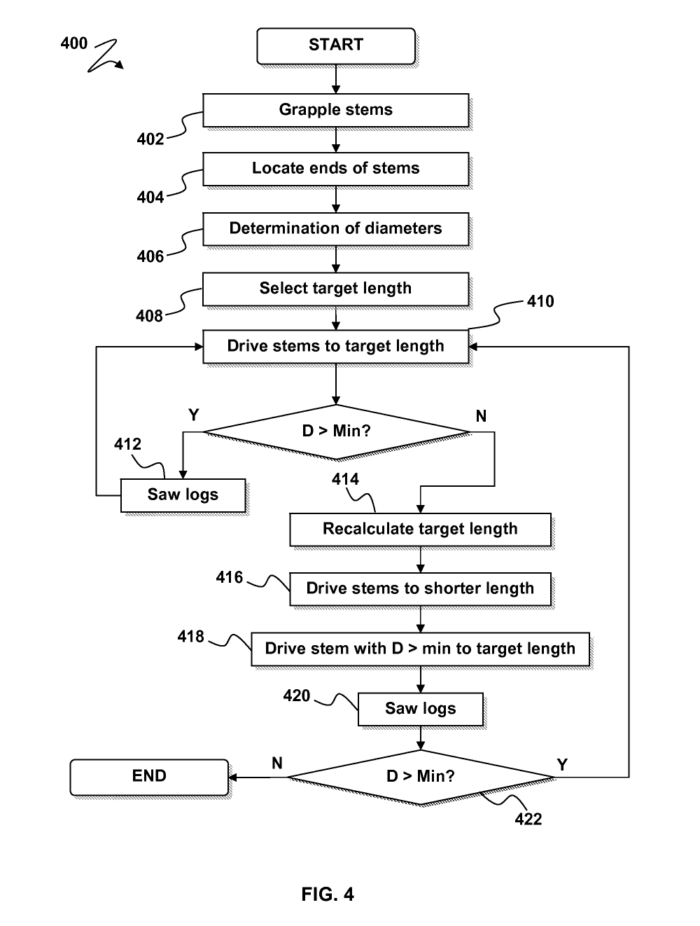

The control system 300 may be configured to implement method 600 of FIG. 4, which will be described with reference to FIGS. 1 through 3 and FIGS. 5A, 5B, and 5C.

In step 402, a human operator operates the operator input device 308 to grasp a first stem and a second stem (stems not illustrated) with the delimb arms 202a and 202b, and feed arms 204a and 204b such that the stems are positioned between the arm-mounted feed wheels 206a and 206b, and frame-mounted feed wheels 208a and 208b. The first stem is positioned to the RH side of the feed axis 212, while the second stem is positioned to the LH side of the feed axis 212.

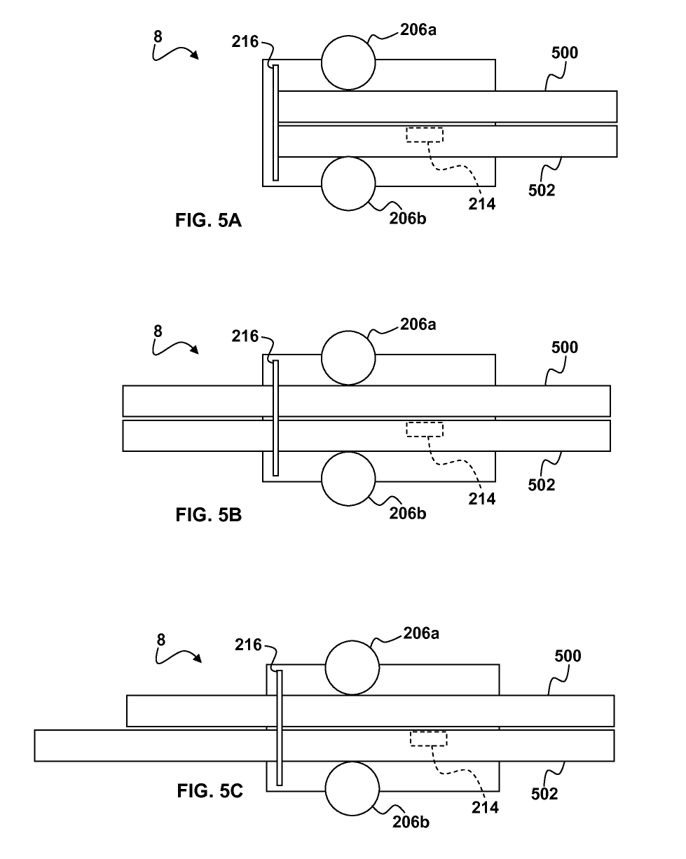

In step 404, the first controller 302 receives from operator input device 308 a signal indicative of a request to find the ends of the stems, or perform a cut using either saw 216 or 218 as appropriate to establish an end position. In response to that signal, the first controller 302 broadcasts an appropriate request on bus 306, which is received by the second controller 304. The second controller 304 actions the request, controlling the various functions of the head 8 as required. Referring to FIG. 5A, the first stem 500 and second stem 502 are aligned at this point, and ready to be processed.

In step 406, the rotation sensors 322a and 322b transmit signals indicating the angular positions of the respective associated arms to the first controller 302 via second controller 304. The first controller 302 determines the relative diameters of the first and second stems 500 and 502. This information may be presented to the operator via monitor 310.

In step 408 the first controller 302 receives from operator input device 308 a signal indicative of a selection for a target length for each of the first and second stems. In an alternative embodiment, the target lengths may be automatically set based on previously entered preferences—or at least proposed to the operator for approval.

In step 410, the first controller 302 broadcasts a request to drive both stems along the feed axis 212 to the target length. The second controller 304 receives the request, and outputs a control signal to drive valves 314a, 314b, 318a and 318b to operate the drives 316a, 316b, 210a, and 210b and thus drive feed wheels 206a, 206b, 208a and 208b.

As the stems are driven, the second controller 304 monitors the output of the rotation sensors 322a and 322b to determine if one or both of stems reaches a minimum diameter before the target length is achieved.

If not, the feed length is measured using the output of wheel encoder 324. When the target length is achieved saw 216 may then be operated to sever the stems in step 412. The process then returns to step 410 for feeding of the stems to the next target length.

If a minimum diameter is reached, the first controller 302 determines a new target length for the stem below diameter in step 414. For example, if the previous target length for the first stem was 16 feet at a 4 inch minimum diameter, the target length may be downgraded to the largest length prior to the diameter going below 4 inches—for example 14 feet.

In step 416, the second controller 304 controls the head 8 such that the first and second stems 500 and 502 are driven to the shorter target length (for example 14 feet), using the output of the wheel encoder 324 to measure length—as illustrated by FIG. 5B.

In step 418, the second stem 502 is driven a further 2 feet to its target length, again using the output of the wheel encoder 324 to measure distance. It should be appreciated that were the first stem 500 to be driven to the longer length, the output of RH arm encoder 320a could be used to measure length during step 418.

Both stems 500 and 502 may then be severed using saw 216 in step 420. If the diameter of the second stem 502 is determined to remain above the minimum diameter in step 422, the process returns to step 410 to continue processing of that stem 502. Otherwise, the remaining portions of the stems 500 and 502 may be ejected and the process reset.

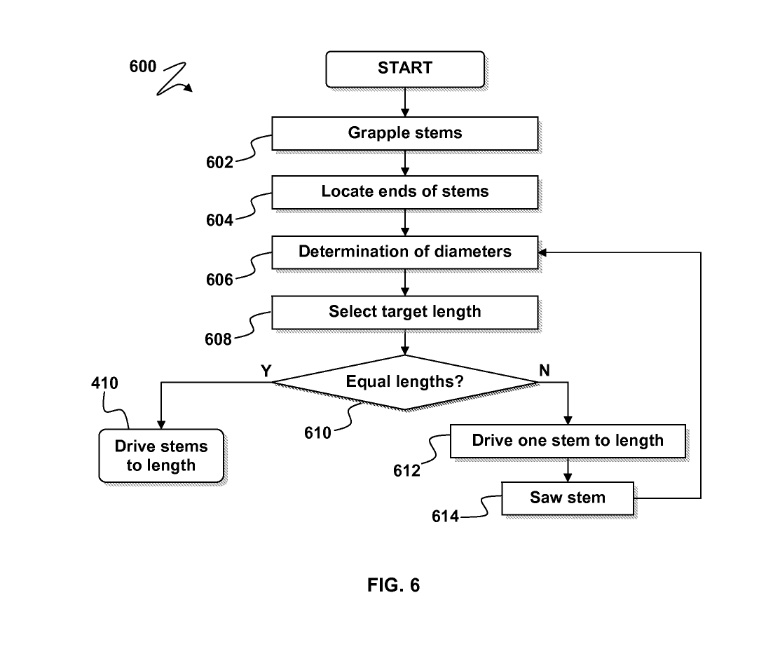

The control system 300 may be configured to implement method 600 of FIG. 6, which will be described with reference to FIGS. 1 through 3 and FIGS. 7A, 7B, and 7C.

In step 602, a human operator operates the operator input device 308 to grasp a first stem and a second stem (stems not illustrated) with the delimb arms 202a and 202b, and feed arms 204a and 204b such that the stems are positioned between the arm-mounted feed wheels 206a and 206b, and frame-mounted feed wheels 208a and 208b. The first stem is positioned to the RH side of the feed axis 212, while the second stem is positioned to the LH side of the feed axis 212.

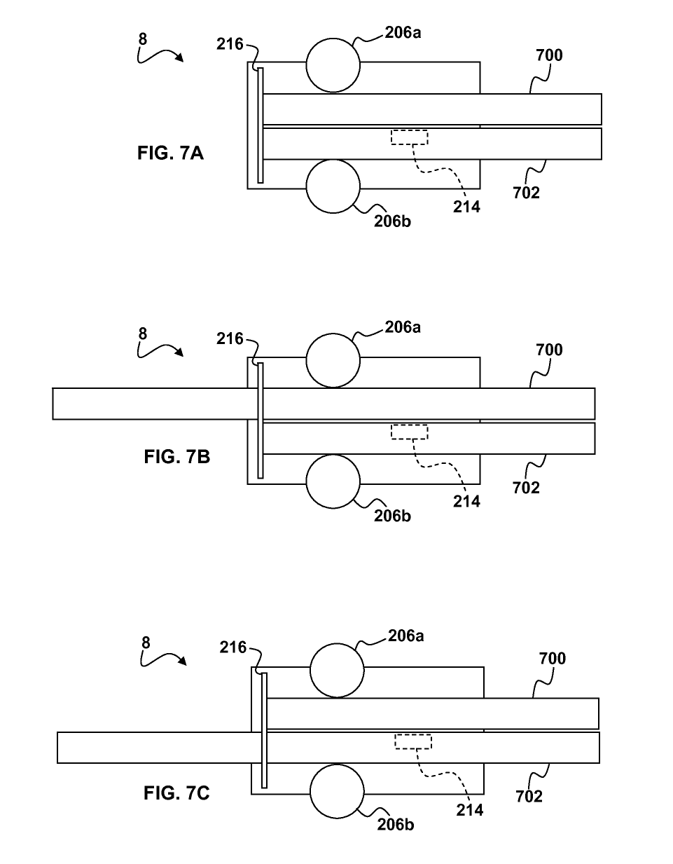

In step 604, the first controller 302 receives from operator input device 308 a signal indicative of a request to find the ends of the stems, or perform a cut using either saw 216 or 218 as appropriate to establish an end position. In response to that signal, the first controller 302 broadcasts an appropriate request on bus 306, which is received by the second controller 304. The second controller 304 actions the request, controlling the various functions of the head 8 as required. Referring to FIG. 7A, the first stem 700 and second stem 702 are aligned at this point, and ready to be processed.

In step 606, the rotation sensors 322a and 322b transmit signals indicating the angular positions of the respective associated arms to the first controller 302 via second controller 304. The first controller 302 determines the relative diameters of the first and second stems 700 and 702. This information may be presented to the operator via monitor 310.

In step 608 the first controller 302 receives from operator input device 608 a signal indicative of a selection for a target length for each of the first and second stems. In an alternative embodiment, the target lengths may be automatically set based on previously entered preferences—or at least proposed to the operator for approval.

If the target lengths of both stems are determined to be the same in step 610, the process may enter step 410 of method 400. If not, in step 612 the first controller 302 broadcasts a request to drive one of the stems along the feed axis 212 to the target length.

For example, in the case of first stem 700 the second controller 304 receives the request, and outputs a control signal to drive valves 314a and 318a to operate the drives 316a and 210a, and thus drive feed wheels 206a and 208a.

As the stem 700 is driven, the second controller 304 monitors the feed length using encoders 320a or 320c. When the target length is achieved—as illustrated in FIG. 7B—saw 216 may then be operated to sever the stems in step 614. The process then returns to step 606 for reassessment of target length.

For example, in the case of second stem 702 the second controller 304 outputs a control signal to drive valves 314b and 318b to operate the drives 316b and 210b, and thus drive feed wheels 206b and 208b.

As the stem 702 is driven, the second controller 304 monitors the feed length using the output of wheel encoder 214 (although in example embodiments encoders 320b or 320d may be used). When the target length is achieved—as illustrated in FIG. 7C—saw 216 may then be operated to sever the stems in step 614. The process then returns to step 606 for reassessment of target length.

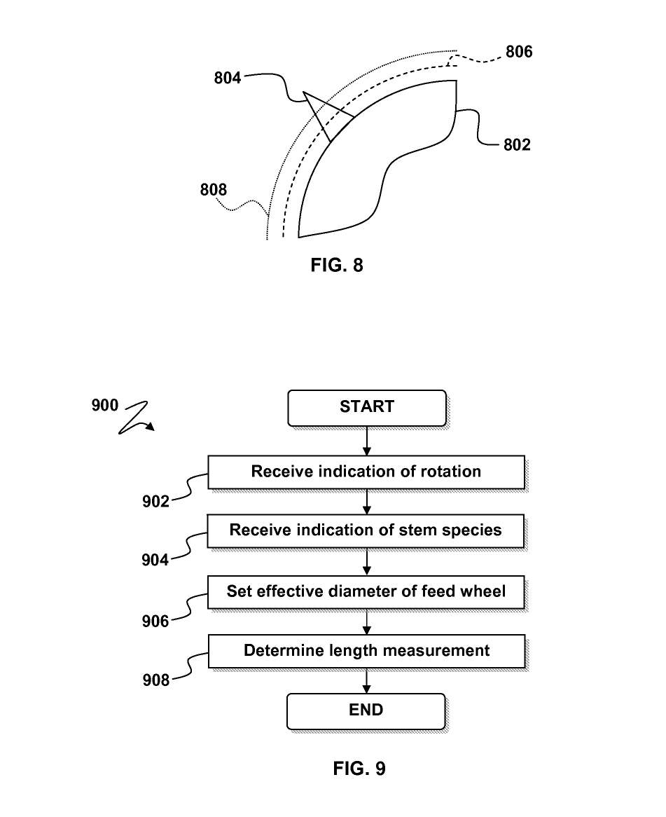

FIG. 8 shows a section of a feed wheel 802 intended to be used, for example, as a feed wheel on a drive arm such as drive arm 204a of FIG. 2. The feed wheel 804 comprises a number of teeth 804 projecting outwardly.

In use, the depth to which the teeth 804 penetrate the surface of a stem is heavily influenced by the tree species of the stem. The effective diameter of the wheel 804 changes depending on the depth of penetration. By way of explanation, dashed line 806 illustrates the effective diameter in the case of a first species, while dotted line 808 illustrates the effective diameter for a second species with a greater density (i.e. less penetration).

FIG. 9 illustrates a method 900 of determining length measurements of stems processed using measurement signals output from a rotary encoder associated with a rotary drive driving a feed wheel—for example RH arm encoder 320a of FIG. 3. Reference may also be made to FIG. 3 when describing method 900.

In step 902, second controller 304 receives the output from encoder 320a indicating the rotation of drive 316a and thus wheel 206a.

In step 904, second controller 304 receives a selection of the species of the stem being processed from first controller 302. It should be appreciated that selection of the species may have been previously selected by the operator.

In step 906, the second controller 304 sets the effective diameter of the wheel 206a based on the selected species.

In step 908, the second controller 304 determines the processed length of the stem using the equation: Length=(Effective Wheel Diameter×π)×Revolutions.

Reference to any prior art in this specification is not, and should not be taken as, an acknowledgement or any form of suggestion that that prior art forms part of the common general knowledge in the field of endeavour in any country in the world.

The disclosure may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the disclosure and without diminishing its attendant advantages. It is therefore intended that such changes and modifications be comprised within the present disclosure.

Aspects of the present disclosure have been described by way of example only and it should be appreciated that modifications and additions may be made thereto without departing from the scope thereof as defined in the appended claims.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that any use of the terms “comprises” and/or “comprising” in this specification specifies the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. Explicitly referenced embodiments herein were chosen and described in order to best explain the principles of the disclosure and their practical application, and to enable others of ordinary skill in the art to understand the disclosure and recognize many alternatives, modifications, and variations on the described example(s). Accordingly, various implementations other than those explicitly described are within the scope of the claims

What is claimed is:

1. A timber-working device, comprising:
a frame, including a feed axis on first and second sides relative to the frame;
a drive system configured to independently feed stems along the feed axis, and having a first rotary drive having a first wheel configured to act against a first stem on the first side of the feed axis, and a second rotary drive having a second wheel configured to act against a second stem on the second side of the feed axis;
at least two distance measurement devices, wherein each side of the feed axis has an associated distance measurement device, each configured to generate measurement signals indicative of the length of stems fed along the feed axis;
wherein at least one of the distance measurement devices is associated with one of the rotary drives and its measurement signal is indicative of rotation of the drive; and
at least one processor configured to:
receive the respective measurement signals; and
for each of the first and second stems, determine the length of at least a portion of the stem fed by the drive system based at least in part on the respective measurement signals.

2. A timber-working device as claimed in claim 1, further comprising a cutting device, and
wherein the processor is configured to control the drive system to feed the first stem and the second stem to respective target lengths to be cut by the cutting device.

3. A timber-working device as claimed in claim 2, further comprising at least one diameter measuring device configured to output a signal indicative of respective diameters of the first stem and the second stem.

4. A timber-working device as claimed in claim 3, wherein the processor is configured to sequentially feed the first and second stems to their respective target lengths on determining that logs resulting from cutting the first and second stems at their target lengths will have differential length and/or diameter characteristics beyond a predetermined threshold.

5. A timber-working device as claimed in claim 3, wherein the processor is configured to adjust the target length of at least one of the stems on determining that the associated diameter is below a minimum diameter threshold.

6. A timber-working device as claimed in claim 3, wherein the processor is configured to prioritise feeding of the stem with the greatest diameter.

7. A timber-working device as claimed in claim 6, wherein the processor is configured to:
control the drive system to feed the stems simultaneously to the shorter of the target lengths; and
control the drive system to subsequently drive one of the stems to the longer of the target lengths.

8. A timber-working device as claimed in claim 1, wherein the first rotary drive is mounted to a first arm pivotally connected to the frame, and the second rotary drive is mounted to a second arm pivotally connected to the frame, and
wherein a third rotary drive having a third wheel configured to act against the first stem is mounted to the frame, and a fourth rotary drive having a fourth wheel configured to act against the second stem is mounted to the frame.

9. A timber-working device as claimed in claim 8, wherein the third and fourth rotary drives are configured to output signals indicative of rotation of the respective drives, and
wherein the processor is configured to:
for each of the first and second stems, determine the length of at least a portion of the stem fed by the drive system based at least in part on rotation of the respective third and fourth rotary drives; and
compare the rate of rotation of the paired first and third rotary drives, and the paired second and fourth rotary drives respectively against an expected rate of rotation; and
where the rate of rotation of one rotary drive deviates from the expected rate of rotation beyond a predetermined threshold, selecting the distance determined from the other rotary drive in the pair for use in further processing.

10. A timber-working device as claimed in claim 1, wherein the processor is configured to:
determine the species of the stem; and
determine the length of at least a portion of each stems based at least in part on the species of the stems.

11. A method for determining the respective lengths of at least portions of a first stem and a second stem independently fed along a feed axis of a timber-working device by a first rotary drive and a second rotary drive respectively, the method comprising the steps of:
receiving measurement signals from distance measurement devices indicative of the length of stems fed along the feed axis, wherein at least one of the measurement signals is indicative of rotation of one of the rotary drives; and
for each of the first and second stems, determining the length of at least a portion of the stem fed by the drive system based at least in part on the respective measurement signals.

12. A method for determining the respective lengths of at least portions of a first stem and a second stem as claimed in claim 11, further comprising:
controlling the drive system to feed the first stem and the second stem to respective target lengths to be cut by a cutting device.

13. A method for determining the respective lengths of at least portions of a first stem and a second stem as claimed in claim 12, further comprising receiving at least one signal indicative of respective diameters of the first stem and the second stem from at least one diameter measuring device.

14. A method for determining the respective lengths of at least portions of a first stem and a second stem as claimed in claim 13, wherein the processor is configured to adjust the target length of at least one of the stems on determining that the associated diameter is below a minimum diameter threshold.

15. A method for determining the respective lengths of at least portions of a first stem and a second stem as claimed in either claim 14, wherein the processor is configured to sequentially feed the first and second stems to their respective target lengths on determining that logs resulting from cutting the first and second stems at their target lengths will have differential length and/or diameter characteristics beyond a predetermined threshold.

16. A method for determining the respective lengths of at least portions of a first stem and a second stem as claimed in claim 14, wherein the processor is configured to:
control the drive system to feed the stems simultaneously to the shorter of the target lengths; and
control the drive system to subsequently drive one of the stems to the longer of the target lengths.

17. A method for determining the respective lengths of at least portions of a first stem and a second stem as claimed in claim 13, wherein the processor is configured to prioritise feeding of the stem with the greatest diameter.

18. A method for determining the respective lengths of at least portions of a first stem and a second stem as claimed in claim 11, further comprising:
receiving signals indicative of rotation of a third rotary drive mounted to a frame of the timber-working device and having a third wheel configured to act against the first stem, and a fourth rotary drive mounted to the frame and having a fourth wheel configured to act against the second stem, wherein the first rotary drive is mounted to a first arm pivotally connected to the frame, and the second rotary drive is mounted to a second arm pivotally connected to the frame;
for each of the first and second stems, determining the length of at least a portion of the stem fed by the drive system based at least in part on rotation of the respective third and fourth rotary drives; and
comparing the rate of rotation of the paired first and third rotary drives, and the paired second and fourth rotary drives respectively against an expected rate of rotation, and
wherein the rate of rotation of one rotary drive deviates from the expected rate of rotation beyond a predetermined threshold, selecting the distance determined from the other rotary drive in the pair for use in further processing.

19. A method for determining the respective lengths of at least portions of a first stem and a second stem as claimed in claim 11, further comprising:
determining the species of the stems; and
wherein determining the length of at least a portion of each stem is based at least in part on the species of the stems.

20. An article of manufacture having computer storage medium storing computer readable program code executable by a computer to implement a method for determining the respective lengths of at least portions of a first stem and a second stem independently fed along a feed axis of a timber-working device by a first rotary drive and a second rotary drive respectively, the code comprising:
computer readable program code receiving measurement signals from distance measurement devices indicative of the length of stems fed along the feed axis, wherein at least one of the measurement signals is indicative of rotation of one of the rotary drives; and
computer readable program code determining, for each of the first and second stems, the length of at least a portion of the stem fed by the drive system based at least in part on the respective measurement signals.
